(19) United States
(12) Patent Application Publication
(10) Pub. No.: US 2016/0189015 A1
(43) Pub. Date: Jun. 30, 2016

(54) DATA EXCHANGE METHODS, SYSTEMS AND APPARATUS USING COLOR IMAGES

(71) Applicant: VASCO DATA SECURITY, INC., OAKBROOK TERRACE, IL (US)

(72) Inventor: FRANK COULIER, GRIMBERGEN (BE)

(21) Appl. No.: 14/985,595

(22) Filed: Dec. 31, 2015

Related U.S. Application Data
(60) Provisional application No. 62/098,432, filed on Dec. 31, 2014.

(51) Int. Cl. G06K 19/06; G06K 7/14

(52) U.S. Cl. CPC G06K 19/0614; G06K 19/06037; G06K 7/1443

(57) ABSTRACT

Methods, apparatus and systems for transferring transaction data using color images are provided.

### CROSS REFERENCE TO RELATED APPLICATIONS

This application claims priority to U.S. Provisional application Ser. No. 62/098,432 entitled DATA EXCHANGE METHODS, SYSTEMS AND APPARATUS USING COLOR IMAGES, filed on Dec. 31, 2014, the contents of which are incorporated fully herein by reference.

### FIELD OF THE INVENTION

The invention relates to securing remote access to computers and applications and remote transactions over computer networks. More specifically, the invention relates to methods and systems for transferring data from a sending device to a receiving device whereby the receiving device may comprise an authentication device and the data being transferred may comprise authentication data such as data to be signed by the authentication device.

### BACKGROUND OF THE INVENTION

As remote access of computer systems and applications grows in popularity, the number and variety of transactions which are accessed remotely over public networks such as the Internet has increased dramatically. This popularity has underlined a need for security; in particular: how to ensure that people who are remotely accessing an application are who they claim they are, how to ensure that transactions being conducted remotely are initiated by legitimate individuals, and how to ensure that transaction data has not been altered before being received at an application server, i.e. how to authenticate users of a computer based application and how to authenticate the transactions these users submit to a computer based application.

In the past, authentication of users relied mostly on the users submitting a static password which was then verified. However, this authentication method was quickly discovered to be quite vulnerable as users tended to choose passwords that were easy to guess or did not protect their passwords well. Other authentication mechanisms have been introduced culminating in solutions whereby transactions being submitted by a user to a computer based application are secured by an electronic signature over data related to the transaction that is submitted. As computer based applications get ever more sophisticated, and also the attacks on these applications get ever more sophisticated, the average volume of data that need to be signed to secure a particular transaction tends to increase. These data need to be transferred from the device hosting the application to the device that generates the electronic signature. A mechanism for exchanging data with an authentication device for generating electronic signatures that is currently gaining popularity is the use of 2D-barcodes that encode the data to be transferred and that may be captured by the receiving device from, for example, a display of the sending device. One way of increasing the size of data that can be exchanged using 2D-barcodes is increasing the resolution of the 2D-barcodes. However there is a practical limit to the resolution of 2D-barcodes due to limitations of the resolution of the cameras required to capture the 2D-barcodes and the increased sensitivity to transmission errors associated with receiving data encoded in high resolution 2D-barcodes.

What are therefore needed are practical and cost effective systems and methods for increasing the size of data transferred using 2D-barcodes.

### DISCLOSURE OF THE INVENTION

Aspects of the invention are based on an insight of the inventor that the information content of a 2D-barcode can be increased with respect to the information content of standard black-and-white coded 2D-barcodes by using a multi-color coding of the 2D-barcode instead of simple black-and-white coding.

Aspects of the invention are further based on another insight of the inventor that an advantageous solution may be obtained if existing processing pipelines for encoding data into black-and-white 2D-barcodes and for processing and decoding black-and-white images containing black-and-white 2D-barcodes can be used.

One aspect of the invention provides a method for transferring data using a color image.

In some embodiments a method for transferring data may comprise the steps of: dividing a set of data into a group of data chunks, encoding each data chunk into an encoded black-and-white 2D-barcode, assembling the thus encoded black-and-white 2D-barcodes into a color barcode image, displaying the color barcode image on a color display of a sending device, capturing a color image of the displayed color barcode image with a camera of a receiving device, filtering the captured color image to obtain a series of black-and-white images, processing each of the obtained series of black-and-white images to extract corresponding black-and-white 2D-barcodes, decoding the extracted black-and-white 2D-barcodes to obtain decoded data chunks, combining the obtained decoded data chunks into a received set of data.

In some embodiments a method for transferring data may comprise the steps of: dividing a set of data into a group of data chunks, encoding at least some of the data chunks into encoded black-and-white 2D-barcodes, assembling at least some of the thus encoded black-and-white 2D-barcodes into a color barcode image, displaying the color barcode image on a color display of a sending device, capturing a color image of the displayed color barcode image with a camera of a receiving device, filtering the captured color image to obtain a series of black-and-white images, processing at least some of the obtained series of black-and-white images to extract corresponding black-and-white 2D-barcodes, decoding at least some of the extracted black-and-white 2D-barcodes to obtain corresponding decoded data chunks, combining at least some of the obtained decoded data chunks into a received set of data.

In some embodiments the set of data may be divided into a group of two or more data chunks. In some embodiments at least two data chunks are encoded into encoded black-and-white 2D-barcodes. In some embodiments at least two encoded black-and-white 2D-barcodes are assembled into a color barcode image.

In some embodiments the step of assembling the encoded black-and-white 2D-barcodes into a color barcode image may comprise determining for each color pixel of the color barcode image black-or-white pixels in each of the encoded black-and-white 2D-barcodes that correspond to that color pixel and determining the color of that color pixel as a function of these corresponding black-or-white pixels. In some embodiments for each encoded black-and-white 2D-barcode a black-and-white 2D-barcode image is determined representing the encoded black-and-white 2D-barcode. In some embodiments for each color pixel of the color barcode image there may be exactly one corresponding black-or-white pixel in each of the black-and-white 2D-barcodes images. In some embodiments each black-or-white pixel in each of the black-and-white 2D-barcode images has exactly one corresponding color pixel in the color barcode image. In some embodiments all the encoded black-and-white 2D-barcodes and the color barcode may have the same dimensions. In some embodiments all the black-and-white 2D-barcode images and the color barcode image may have the same dimensions.

In some embodiments a method for transferring a set of data using a color image may comprise the steps of: dividing the set of data into a group of two or more data chunks; assembling a color barcode image encoded with the set of data, wherein the color barcode represents a superposition of black-and-white 2D-barcode images, one black-and-white 2D-barcode image for each of said data chunks; displaying the color barcode image on a color display of a sending device; capturing the displayed color image with a camera of a receiving device; filtering the captured color image to obtain a series of black-and-white images; processing each of the obtained series of black-and-white images to extract corresponding black-and-white 2D-barcodes; decoding each of the extracted black-and-white 2D-barcodes to obtain corresponding decoded data chunks; and combining the obtained decoded data chunks into a received set of data.

In some embodiments the method may further comprise: encoding each data chunk into an encoded black-and-white 2D-barcode; assembling the encoded black-and-white 2D-barcodes into a color barcode image wherein for each pixel of the color barcode image a corresponding black-or-white element is determined in each of the encoded black-and-white 2D-barcodes, and the color of each pixel of the color barcode image is determined as a function of the values of said determined corresponding black-or-white elements.

In some embodiments the method may further comprise: encoding each data chunk into an encoded black-and-white 2D-barcode; generating for each encoded black-and-white 2D-barcode an intermediate black-and-white image, wherein all intermediate black-and-white images have the same dimensions; assembling the intermediate black-and-white images into a color barcode image having the same dimensions as the intermediate black-and-white images, wherein for each pixel of the color barcode image the color of that pixel is determined as a function of the values of corresponding black-or-white pixels in each of the encoded black-and-white 2D-barcodes.

In some embodiments one or more of the encoded black-and-white 2D-barcodes may be formatted according to an established 2D-barcode standard. In some embodiments one or more or all of the encoded black-and-white 2D-barcodes may comprise a QR code (Quick Response Code).

In some embodiments all encoded black-and-white 2D-barcodes may be formatted according to the same format. In some embodiments all encoded black-and-white 2D-barcodes may have the same dimensions.

Another aspect of the invention provides an apparatus for receiving data encoded in a color image. In some embodiments the apparatus may be used with any of the methods of the embodiments described elsewhere in this description.

In some embodiments the apparatus may comprise: a camera for capturing a digital color image; a data processing component adapted to process the captured digital color image wherein said processing may comprise filtering the captured color image to obtain a series of black-and-white images, processing each of the obtained series of black-and-white images to extract corresponding black-and-white 2D-barcodes, decoding the extracted black-and-white 2D-barcodes to obtain decoded data chunks, combining the obtained decoded data chunks into a received set of data.

In some embodiments the apparatus may comprise: a camera for capturing a digital color image; a data processing component adapted to process the captured digital color image wherein said processing may comprise filtering the captured color image to obtain a series of black-and-white images, processing at least some of the obtained series of black-and-white images to extract corresponding black-and-white 2D-barcodes, decoding at least some of the extracted black-and-white 2D-barcodes to obtain corresponding decoded data chunks, combining at least some of the obtained decoded data chunks into a received set of data.

In some embodiments said processing of each of the obtained series of black-and-white images to extract corresponding black-and-white 2D-barcodes may comprise: processing a first black-and-white image of the obtained series of black-and-white images, wherein said processing of said first black-and-white image comprises analysing said first black-and-white image to obtain a set of parameters; and using said obtained set of parameters in processing at least one black-and-white image of the obtained series of black-and-white images that is different from the first black-and-white image. Said obtained set of parameters may also be used in processing the first black-and-white image and may be re-used in processing other black-and-white images of the obtained series of black-and-white images.

In some embodiments the set of parameters may comprise a scaling parameter and/or a rotation parameter and/or one or more distortion parameters (which may comprise projective distortion parameters). In some embodiments these parameters may be related to the distortion and/or deformation and/or transformation that the color barcode image may have gone through in the process of being displayed on a display and being captured from that display as a captured digital color image.

In some embodiments the series of black-and-white images comprises at least two black-and-white images.

In some embodiments the data processing component may further be adapted to generate an electronic signature over the received set of data.

In some embodiments the apparatus may further comprise a user output interface for presenting messages and/or data to a user of the apparatus, and a user input interface to receive inputs from the user, whereby the apparatus may be further adapted to present using the user output interface the received set of data to the user for review, to receive from the user using the user input interface an indication of approval or rejection of the presented received set of data, and to generate and/or make available the electronic signature over the received set of data only on condition that the apparatus received from the user an indication of approval of the presented received set of data.

Yet another aspect of the invention provides a system for transferring a set of data to a receiving apparatus using a color image. In some embodiments the system may be used with any of the methods or apparatus of the embodiments described elsewhere in this description.

In some embodiments the system may comprise an encoding unit adapted to generate a color barcode image encoding the set of data by dividing the set of data into a group of data chunks, encoding each data chunk into an encoded black-and-white 2D-barcode, and assembling the encoded black-and-white 2D-barcodes into a color barcode image; and the system may further comprise a sending device comprising a color display for displaying the generated color barcode image.

In some embodiments the system may comprise an encoding unit adapted to generate a color barcode image encoding the set of data by dividing the set of data into a group of data chunks, encoding at least some of the data chunks into corresponding encoded black-and-white 2D-barcodes, and assembling at least some of the encoded black-and-white 2D-barcodes into a color barcode image; and the system may further comprise a sending device comprising a color display for displaying the generated color barcode image.

In some embodiments the set of data may be divided into a group of two or more data chunks. In some embodiments at least two data chunks are encoded into encoded black-and-white 2D-barcodes. In some embodiments at least two encoded black-and-white 2D-barcodes are assembled into a color barcode image.

More details of various aspects of the invention are given in the following paragraphs.

Assembling a color barcode image, encoded with a set of data, as a (virtual) superposition of black-and-white 2D-barcodes.

In some embodiments a color barcode encoded with a set of data may be assembled as follows. In some embodiments, the set of data may be divided in a group of N data chunks (wherein N may be a positive integer larger than 1), and a color barcode image may be assembled that represents a (virtual) superposition of N black-and-white 2D-barcodes, one (virtual) black-and-white 2D-barcode for each data chunk.

In some embodiments each data chunk may be encoded into a binary symbol string whereby each binary symbol in such a symbol string codes the black-or-white value of a corresponding element of a black-and-white 2D-barcode (such as for example a black-or-white square in a black-and-white 2D-barcode comprising or consisting of a grid of black-or-white squares). A series of black-and-white 2D-barcodes may then be generated whereby each black-and-white 2D-barcode represents one of the symbol strings encoding one of the data chunks of the set of data. For each black-and-white 2D-barcode of this series a temporary intermediate black-and-white image may be generated representing that black-and-white 2D-barcode, whereby the process of generating the temporary intermediate black-and-white images may be such that all generated temporary intermediate black-and-white images have the same shape and dimensions. In some embodiments all the black-and-white 2D-barcodes may already have the same shape and dimensions so that this step of generating the temporary intermediate images all having the same shape and dimensions and representing one of the 2D-barcodes may be trivial. In some embodiments a color barcode image may be generated that may have the same shape and dimensions as the temporary intermediate black-and-white images. In some embodiments the color coding of the pixels of the color barcode image may be determined as follows. Each black-or-white pixel of each temporary intermediate black-and-white image can only have one of two color values, i.e. black or white, and thus corresponds to one bit. For each color pixel of the color barcode image a bit string may be determined consisting of the concatenated bit values of the corresponding pixels in each of the temporary intermediate black-and-white images (wherein corresponding pixels may be determined as pixels that have the same coordinates). Since there are N temporary intermediate black-and-white images, each bit string has N bits and each bit string may therefore have one of 2̂N different possible values (wherein the symbol “̂” is used to denote the mathematical exponentiation operation). A number of K encoding colors may be predefined whereby K may be an integer number equal to 2̂N. To each of the K encoding colors a different one of the 2̂N possible values for the bit strings may be assigned, or, seen the other way round, to each different one of the 2̂N possible bit string values a different one of the K encoding colors may be assigned. The color of each individual pixel of the color barcode image may then be determined by assigning to that pixel the encoding color that corresponds to the value of the bit string that was determined for that pixel.

In some embodiments the encoding colors (which colors as well as the number of colors) may not be predefined but may be chosen, e.g. as a function of the amount of data to be transferred and/or the number of black-and-white 2D-barcodes. In some embodiments an indication of which colors have been chosen to be the encoding colors may also be included into the color barcode image.

In this description assembling black-and-white 2D-barcodes into a color barcode image may also be referred to as bundling the black-and-white 2D-barcodes into the color barcode image.

For example in some embodiments a data set consisting of, for example, a string of 2*B bytes, may be divided in two strings of B bytes each (whereby B is an integer number). Each string of B bytes may be encoded into a black-and-white 2D-barcode, such as for example a QR code. The two encoded black-and-white 2D-barcodes may have the same format. That is, they may have the same shape, dimensions and number of elements (e.g. the black and white squares that together make up the black-and-white 2D-barcodes). The two encoded black-and-white 2D-barcodes may be bundled into a single color barcode which may have the same shape, dimensions and number of elements as each of the two encoded black-and-white 2D-barcodes. This means that with each element of the color barcode a corresponding element in the first black-and-white 2D-barcode and another corresponding element in the second black-and-white 2D-barcode can be naturally identified (e.g. corresponding elements may be defined as elements that have the same positions or coordinates in their respective barcodes). For each element of the color barcode, the pair of corresponding elements in the black-and-white 2D-barcodes can have four different color combinations. That is, both elements may be white (combination ‘white-white”), both elements may be black (combination ‘black-black’), the element of the first black-and-white 2D-barcode may be white and the element of the second black-and-white 2D-barcode may be black (combination ‘white-black’), or the element of the first black-and-white 2D-barcode may be black and the element of the second black-and-white 2D-barcode may be white (combination ‘black-white’). The color of each element of the color barcode may then be chosen among four predefined encoding colors. These four predefined encoding colors may for example comprise “black”, “red”, “green”, and “blue”. The color of an element whose corresponding black-and-white elements have the combination ‘black-black’ may then be set to “black”; the color of an element whose corresponding black-and-white elements have the combination ‘white-white’ may then be set to “blue”, the color of an element whose corresponding black-and-white elements have the combination ‘white-black’ may then be set to “green”, and the color of an element whose corresponding black-and-white elements have the combination ‘black-white’ may then be set to “red”. In some embodiments the resulting color barcode image may be represented or displayed on, for example, the display of a sending device. Although assembly of two black-and-white 2D-barcodes into a single color 2D-barcodes is described in detail, it is to be understood that more black-and-white 2D-barcodes may be combined into a single color 2D-barcode in a similar manner.

In some embodiments shortcuts may be taken with respect to the color barcode assembly method described above.

For example in some embodiments the step of explicitly generating intermediate black-and-white images may be skipped. Instead of determining for each color pixel of the color barcode the corresponding black-or-white pixels of the intermediate black-and-white images and determining the color of that color pixel as a function of the black-or-white values of these corresponding black-or-white pixels, in some embodiments the color of a particular color pixel may be determined as follows. For each color pixel the black-or-white element in each of the N black-and-white 2D-barcodes that corresponds to this color pixel may be determined, whereby the corresponding black-or-white element in a given black-and-white 2D-barcode for a color pixel may be determined as the black-or-white element that would determine the value of the corresponding black-or-white pixel in an intermediate black-and-white image that would otherwise have been generated for that black-and-white 2D-barcode. Instead of determining the color of the color pixel as a function of the values of the black-or-white pixels corresponding to that color pixel, the color of the color pixel may then directly be determined as a function of the values of these corresponding black-or-white elements.

In some embodiments an extra shortcut may be applied. In some embodiments the step of explicitly generating the black-or-white 2D-barcodes from the symbol strings may be skipped. In some embodiments for at least some of the color pixels rather than determining the color of such a color pixel as a function of the values of the black-or-white elements corresponding to that color pixel, the color of that color pixel may be directly determined as a function of the symbol values of the various symbols in the N symbol strings that correspond to that color pixel, whereby for a given color pixel the symbol in each of the N symbol strings that corresponds to this color pixel may be determined as the symbol that would define the value of the corresponding black-and-white element of the black-and-white 2D-barcode encoding the symbol string if such a black-and-white 2D-barcode would be generated.

In some embodiments some or all of the steps for encoding a set of data into a color barcode may be performed at a server, such as an application server hosting a server part of a remotely accessible computer based application. In some embodiments some or all of the steps for encoding a set of data into a color barcode may be performed at an access device (such as smartphone or a Personal Computer), that a user may be using for accessing a remotely accessible computer based application.

In some embodiments, once the color barcode has been assembled, it may be displayed. In some embodiments the color barcode may be displayed as a color image for example on the display of an access device that a user may be using for accessing a remotely accessible computer based application. In some embodiments the color barcode may be printed e.g. on a letter.

Capturing a color image representing a color barcode.

In some embodiments a receiving device may capture a color image of the displayed color barcode image. For example the receiving device may use a camera to make a photo of a portion or area of the display of the sending device that comprises the displayed color barcode image.

In general the color image of the displayed color barcode image may comprise a representation of the displayed color barcode image that in many aspects may be imperfect e.g. due to noise and distortions. For example the pixels of the representation of the color barcode image in the captured image may be surrounded by pixels that don't belong to the representation of the color barcode image. The representation of the color barcode image in the captured color image may be a distorted, scaled and/or rotated version of the actual displayed color barcode image, e.g., due to variations in the orientation of the receiving device with respect to the sending device. The colors of some pixels of the representation of the color barcode image in the captured color image may not be the same (they might for example have a somewhat different hue or a different saturation) as the encoding colors of the pixels of the original color barcode image that the captured pixels correspond to, for example due to reflections on the display of the sending device.

Extracting a set of data from a captured color image.

In some embodiments the receiving device may process the captured color image to extract the data encoded in the original color barcode image of which the captured color image comprises a representation.

Filtering a captured color image to obtain a series of black-and-white images

In some embodiments processing a captured color image that is assumed to have been encoded with data may comprise obtaining a series of N raw black-and-white images that may have the same dimensions as the captured color image. In some embodiments obtaining a series of N black-and-white images from the color image may be done as follows.

In some embodiments each pixel in each raw black-and-white image may correspond to a specific captured color pixel in the captured color image. In some embodiments the N raw black-and-white images and the captured color image may have the same dimensions, and the corresponding captured color pixel of any particular black-or-white pixel in each raw black-and-white image may be determined as the captured color pixel that has the same coordinates as that particular black-or-white pixel.

In some embodiments the value (i.e. black or white) of each particular black-or-white pixel in each raw black-and-white image may be determined as a function of: on the one hand the color of the captured color pixel that this particular black-or-white pixel corresponds to and on the other hand which particular raw black-and-white image that particular black-or-white pixel belongs to. By numbering the N different raw black-and-white images and using the symbol ‘i’ to denote the number of a particular raw black-and-white image, this may be reformulated as follows: the value of a particular black-or-white pixel of the i-th raw black-and-white image may be determined as a function of on the one hand the color of the captured pixel that corresponds to this particular black-or-white pixel, and on the other hand the number i of the particular raw black-and-white image that this particular black-or-white pixel belongs to.

Determining the value of black-or-white pixels as a function of the color of corresponding captured color pixels.

In some embodiments each captured pixel of the captured color image may each be assigned to one of K (whereby K may be an integer number equal to 2̂N) pixel groups or pixel types, whereby the pixel group or pixel type to which a particular captured pixel is assigned may be a function of the color of that particular captured pixel. This mapping or assignment of captured pixels to K pixel groups may be such that all the captured pixels of the same group may (ideally) be supposed to correspond to pixels in the original color barcode image that have the same encoding color.

For example in some embodiments a set of K filtering colors may be determined whereby each different filtering color may be associated with a different pixel group of the K pixel groups. In some embodiments for each captured pixel of the captured color image one filtering color from the determined set of K filtering colors may be determined to be the filtering color that is closest to the actual color of that captured pixel and that captured pixel may be assigned to the pixel group associated with that particular filtering color.

In some embodiments the filtering colors of the set of K filtering colors may be predefined. In other embodiments the filtering colors (which colors as well as the number of colors) may not be predefined but may for example be determined on the basis of characteristics of the captured color image. For example in some embodiments the filtering colors may be determined by applying a clustering algorithm to the set of all the actual colors appearing in the captured color image. In some embodiments such a clustering algorithm may take into account a distance metric for determining the degree of similarity or difference between any two colours. In some embodiments such a clustering algorithm may for example take into account the number of pixels that have been colored with each particular color. In some embodiments the number K of clustering groups is predefined and the clustering algorithm may be adapted to cluster the colors of the captured image in K groups. In other embodiments the number of clusters is not predefined and the clustering algorithm may be adapted to determine clustering groups and the number of filtering colors may then be determined as a function of the discovered clustering groups and their number. For example in some embodiments the number of filtering colors may be determined as the number of filtering groups that have been found and that satisfy some minimal prominence criterion.

In some embodiments for each of the K determined clustering groups a filtering color may be determined (e.g. the colour of that clustering group that has the most pixels), and each captured pixel may be assigned to one of these filtering colors, for example as explained above. In some embodiments each captured pixel may be directly assigned to one of the K determined clustering groups. For example a clustering algorithm may be used that clusters captured pixels in K groups based on their color.

The value of a particular black-or-white pixel of the i-th raw black-and-white image may now be determined as a function of on the one hand the pixel group to which the captured pixel corresponding to this particular black-or-white pixel has been assigned, and on the other hand the number i of the particular raw black-and-white image that this particular black-or-white pixel belongs to.

For example, each different filtering color of the set of K filtering colors, or more generally each different pixel group of the set of K filtering groups, may correspond to a unique N-bit filtering value. The series of N black-and-white images may then be obtained by determining the black or white value of each black-or-white pixel of the i-th image of the series of N black-and-white images based on the bit value of the i-th bit of the N-bit filtering value that corresponds to the filtering color (or pixel group) that was determined for the corresponding captured pixel in the captured color image (wherein ‘i’ is a number that ranges from 1 to N and represents an individual one of the series of N black-and-white images). In some embodiments each of the K filtering colors may preferably be the same or very similar to a corresponding one of the K encoding colors that may have been used for generating the color barcode image as mentioned above. In some embodiments for each of the K filtering colors the N-bit filtering value corresponding to that filtering color may preferably be the same as the bit string value to which the encoding color corresponding to the filtering color has been assigned.

In this description filtering a captured color image to obtain a series of black-and-white images may also be referred to as unbundling or unpacking a captured color image.

For example in some embodiments there may be four predefined filtering colors, for example “black”, “red”, “green”, and “blue”. As there are four different filtering colors, each filtering color may be associated with a unique 2-bit value. For example, ‘00’ may be associated with “black”, ‘01’ with “red”, ‘10’ with “green”, and ‘11’ with “blue”. In accordance with this example, to obtain a series of two black-and-white images from a captured color image, each pixel of the first black-and-white image is processed such that it is set to black if the color of the corresponding captured pixel in the captured color image is closer to either the filtering colors “black” or “red” rather than to the filtering colors “green” or “blue”, and it is set to white otherwise; similarly, each pixel of the second black-and-white image is processed such that it is set to black if the color of the corresponding captured pixel in the captured color image is closer to either the filtering colors “black” or “green” rather than to the filtering colors “red” or “blue”, and it is set to white otherwise.

In some embodiments each of the N raw black-and-white images that may have been obtained as described above may comprise an imperfect (e.g. distorted, scaled, rotated and/or noisy) representation of a corresponding one of the original black-and-white 2D-barcodes that were assembled into the original color barcode image.

Processing the obtained raw black-and-white images.

In some embodiments each of the N raw black-and-white images may be processed to obtain or reconstruct the original corresponding black-and-white 2D-barcodes, and each of these obtained or reconstructed black-and-white 2D-barcodes may be decoded to retrieve the data chunks that were encoded in them. In some embodiments at least one of the N raw black-and-white images may be processed with a standard processing pipeline for recovering a standard coded black-and-white 2D-barcode from a black-and-white image, to recover the original corresponding black-and-white 2D-barcode and/or to recover the data chunk encoded in the original corresponding black-and-white 2D-barcode. In some embodiments all the N raw black-and-white images may be processed with a standard processing pipeline to recover the original corresponding black-and-white 2D-barcodes and/or to recover the data chunks encoded in the original corresponding black-and-white 2D-barcodes. In some embodiments at least one or some of the N raw black-and-white images may be processed with a part of the standard processing pipeline to recover the original corresponding black-and-white 2D-barcode and/or to recover the data chunk encoded in the original corresponding black-and-white 2D-barcode.

In general, as they may have been obtained from the same captured color image comprising a representation of the original color barcode image, all the representations of the original black-and-white 2D-barcodes that are comprised in the various obtained N raw black-and-white images may have at least some of the distortions or deformations (such as for example rotations and projective distortions) in common. In some embodiments at least one, or some but not all, of the N raw black-and-white images may be fully processed with a standard processing pipeline while for the remaining raw black-and-white images some stage(s) of the standard processing pipeline may be skipped using instead results of the processing of the raw black-and-white images that have already been processed using the full standard processing pipeline. More in particular in some embodiments stages of the standard processing pipeline that may analyse distortions or deformations that may be common to all of the N raw black-and-white images may be applied only to one or some (but not all) of the N raw black-and-white images and the results of the analysing of these one or some (but not all) of the N raw black-and-white images with these stages may be used in the processing of the remaining raw black-and-white images by skipping these analysis stages for the remaining raw black-and-white images and instead re-use the results of the analysis already carried out on the one or some (but not all) of the N raw black-and-white images that have been fully analysed.

For example in some embodiments the standard processing pipeline may comprise a stage that may analyse a raw image to estimate the scaling and/or distortions and/or rotations to which the original black-and-white 2D-barcode represented in the raw image may have been subjected, whereby that analysing stage may, for example, determine parameters for a following stage, such as a transformation stage for undoing the projective distortion and/or rotation to which the original black-and-white 2D-barcode represented in the raw image may have been subjected. In some embodiments this analysing stage may be performed on one (or some but not all) of the N raw black-and-white images and the parameters that result from this analysis may also be used directly for the transformation stage for all remaining raw black-and-white images whereby the analysis stage may be skipped for these remaining raw black-and-white images.

Combine recovered data chunks.

In some embodiments the receiving device may be adapted to combine the data chunks that were recovered by processing the various black-and-white images into a single received set of data. For example in some embodiments the recovered data chunks may be simply concatenated in a particular order. In some embodiments this order is implicitly defined by the particular black-and-white image that each data chunks has been recovered from, wherein the inherent order of the black-and-white image may be defined by the particular color coding scheme that is used in generating the color image. In some embodiments the recovered data chunks may each contain a payload and the receiving device may obtain the received set of data by combining the various payloads of the various data chunks. In some embodiments the payloads may for example be concatenated in a particular order. In some embodiments this order is implicitly defined by the particular black-and-white image that each data chunks has been recovered from, wherein the inherent order of the black-and-white image may be defined by the particular color coding scheme that is used in generating the color image. In some embodiments the order in which to combine the payloads may be explicitly indicated by data elements in the data chunks.

### BRIEF DESCRIPTION OF THE DRAWINGS

The foregoing and other features and advantages of the described embodiments will be apparent from the following, more particular description of embodiments of aspects of the invention, as illustrated in the accompanying drawings.

FIG. 1 schematically illustrates an exemplary apparatus according to an aspect of the invention.

FIG. 2 schematically illustrates an exemplary method according to an aspect of the invention.

FIG. 3 schematically illustrates an exemplary system according to an aspect of the invention.

### DETAILED DESCRIPTION

Some implementations of the described embodiments are discussed below. While specific implementations are discussed, it should be understood that this is done for illustration purposes only. A person skilled in the relevant art will recognize that other components and configurations may be used without parting from the spirit and scope of the invention.

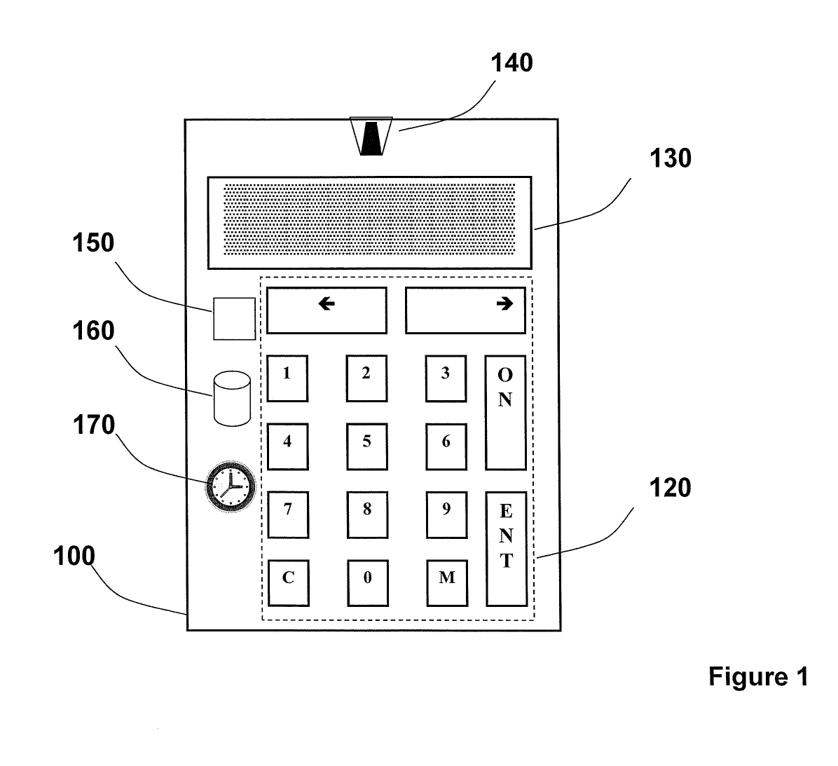

FIG. 1 schematically illustrates an exemplary apparatus (100) according to an aspect of the invention. In some embodiments the apparatus may be used with any of the methods or systems described elsewhere in this description.

In some embodiments the apparatus may comprise a camera (140) for capturing a digital color image and a data processing component (150) adapted to process the captured digital color image. In some embodiments the data processing component may be adapted to process the captured digital color image by filtering the captured color image to obtain a series of black-and-white images, processing each obtained black-and-white image to extract a corresponding black-and-white 2D-barcode, decoding the extracted black-and-white 2D-barcode to obtain decoded data chunks, and combining the obtained decoded data chunks into a received set of data, as explained in more detail elsewhere in this description.

In some embodiments the data processing component may be further adapted to generate an electronic signature over (at least a part of) the received set of data. In some embodiments the apparatus may further comprise a memory component (160) e.g. for storing a cryptographic secret that the apparatus may use for generating the electronic signature for example by applying a cryptographic algorithm over the received set of data whereby that cryptographic algorithm may be parameterized with the stored cryptographic secret. For example in some embodiments the cryptographic secret may comprise a symmetric cryptographic key and generating the electronic signature may comprise applying to (at least a part of) the received set of data a symmetric cryptographic algorithm, such as a symmetric encryption or decryption algorithm such as for example AES (Advanced Encryption Standard) or a keyed hashing algorithm, that may be parameterized with the symmetric cryptographic key. For example in some embodiments the cryptographic secret may comprise a private key of an asymmetric public/private key pair and generating the electronic signature may comprise applying to (at least a part of) the received set of data an asymmetric cryptographic algorithm, such as for example RSA (Rivest-Shamir-Adleman), that may be parameterized with the private key.

In some embodiments the apparatus may further comprise a component (170) for providing the value of a dynamic variable and the apparatus may be further adapted to include this dynamic variable value in the generation of the electronic signature. For example in some embodiments the apparatus may comprise a clock (170) for providing a time value which the apparatus may include as a data element in the generation of the electronic signature.

In some embodiments the apparatus may further comprise a user output interface (130) for presenting messages and/or data to a user of the apparatus, and/or a user input interface (120) to receive inputs from the user. In some embodiments the apparatus may be further adapted to present using the user output interface (at least a part of) the received set of data to the user for review, to receive from the user using the user input interface an indication of approval or rejection of the presented (part of the) received set of data, and to generate and/or make available the electronic signature over (the part of) the received set of data only on condition that the apparatus received from the user an indication of approval of the presented (part of the) received set of data. In some embodiments the user input interface may for example comprise a keyboard or a touch screen. In some embodiments the user output interface may for example comprise a display and/or a loudspeaker and a component for generating synthetic speech.

In some embodiments the apparatus may comprise a personal computing device such a smartphone. In some embodiments the apparatus may comprise a dedicated hardware authentication device whereby the authentication device may be dedicated to providing authentication functionality.

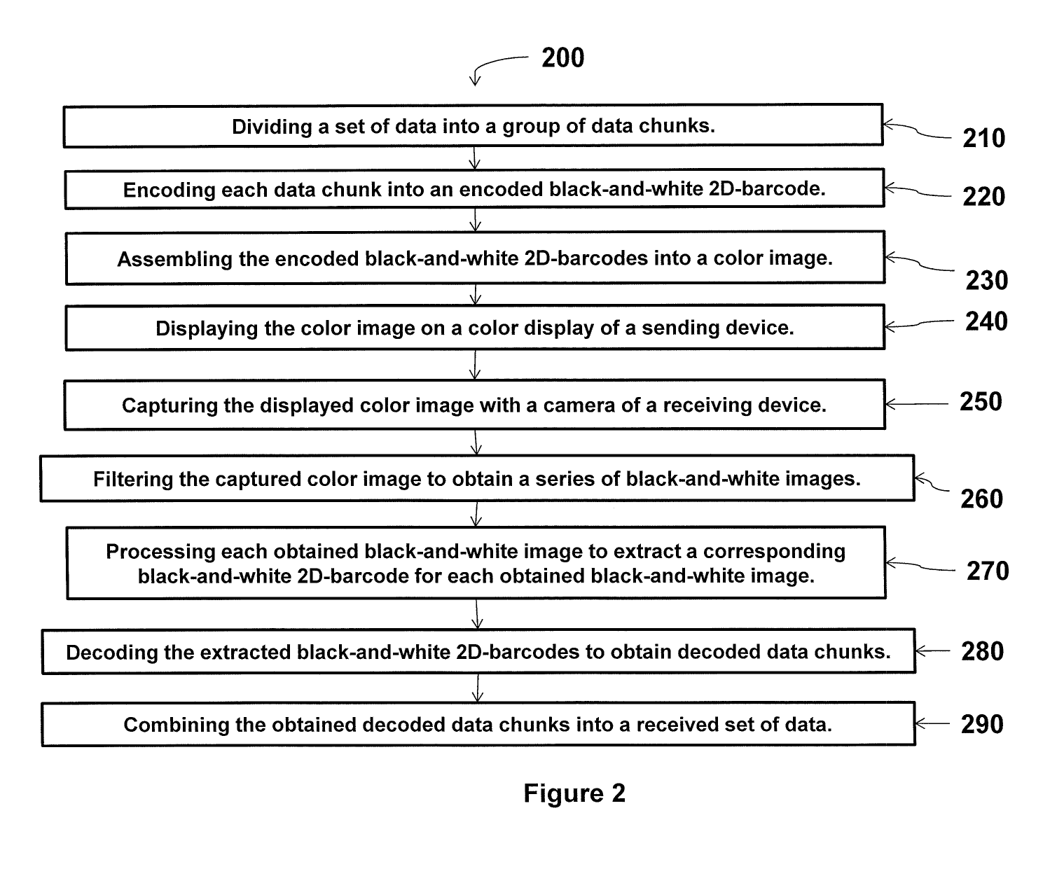

FIG. 2 schematically illustrates an exemplary method (200) according to an aspect of the invention. Various embodiments of the method may be used with any of the systems or apparatus described elsewhere in this description.

In some embodiments the method may comprise the steps of: dividing (210) a set of data into a group of two or more data chunks; encoding (220) each data chunk into an encoded black-and-white 2D-barcode; assembling (230) the encoded black-and-white 2D-barcodes into a color barcode image; displaying (240) the color barcode image on a color display of a sending device; capturing (250) a color image of the displayed color barcode image with a camera of a receiving device; filtering (260) the captured color image to obtain a series of black-and-white images; processing (270) each obtained black-and-white image to extract a corresponding black-and-white 2D-barcode for each obtained black-and-white image; decoding (280) the extracted black-and-white 2D-barcodes to obtain decoded data chunks; and combining (290) the obtained decoded data chunks into a received set of data.

In some embodiments the method may comprise the steps of: encoding a set of data into an encoded color barcode image; displaying (240) the color barcode image on a color display of a sending device; capturing (250) a color image of the displayed color barcode image with a camera of a receiving device; filtering (260) the captured color image to obtain a series of black-and-white images; processing (270) each obtained black-and-white image to extract a corresponding black-and-white 2D-barcode for each obtained black-and-white image; decoding (280) the extracted black-and-white 2D-barcodes to obtain decoded data chunks; and combining (290) the obtained decoded data chunks into a received set of data.

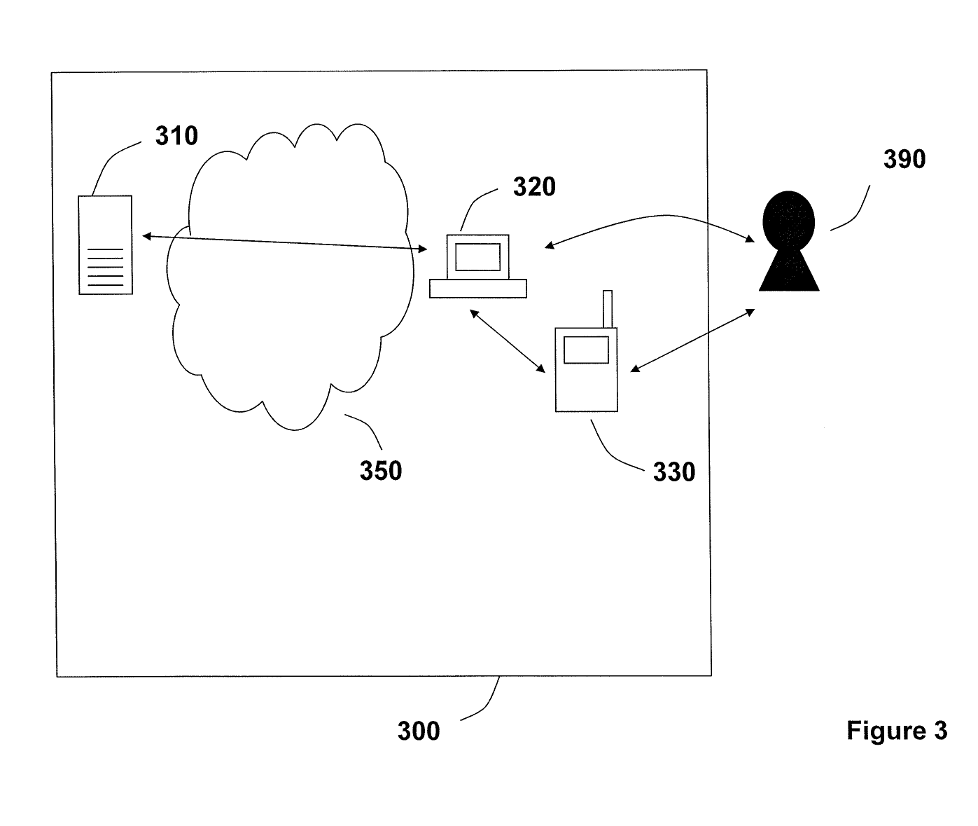

FIG. 3 schematically illustrates an exemplary system (300) according to an aspect of the invention. In some embodiments the system may be used with any of the methods or apparatus described elsewhere in this description.

In some embodiments the system may be adapted to transmit data (such as for example application data that needs to be reviewed and/or approved and/or signed) to a receiving device.

In some embodiments the system may comprise an encoding unit (310) that may be adapted to generate a color barcode image encoding the set of data. In some embodiment the encoding unit may be adapted to generate a color barcode image encoding the set of data by dividing the set of data into a group of data chunks, encoding each data chunk into an encoded black-and-white 2D-barcode, and assembling the encoded black-and-white 2D-barcodes into a color barcode image. In some embodiments the system may further comprise a sending device (320) comprising a color display for displaying the generated color image.

In some embodiments the encoding unit (310) may for example comprise an application server that may for example host a computer based application. In some embodiments the encoding unit may for example comprise a web server. In some embodiments, the encoding unit (310) may be integrated into the sending device (320).

In some embodiments the sending device (320) may for example comprise an access device that a user (390) may use to access the computer based application. In some embodiments the sending device may for example comprise a Personal Computer, a laptop, a tablet computer, or a smartphone.

In some embodiments the sending device and the encoding unit may be connected by a computer network (350), such as a local area network, a wide area network and/or a combination of each that may include a telecommunications network and/or the internet.

In some embodiments the receiving device (330) may for example comprise an authentication device. In some embodiments the receiving device may for example comprise a smartphone or a hardware device dedicated to authentication functions such as generating electronic signatures.

A number of implementations have been described. Nevertheless, it will be understood that various modifications may be made. For example, elements of one or more implementations may be combined, deleted, modified, or supplemented to form further implementations. Accordingly, other implementations are within the scope of the appended claims. In addition, while a particular feature may have been disclosed with respect to only one of several implementations, such feature may be combined with one or more other features of the other implementations as may be desired and advantageous for any given or particular application. With respect to embodiments of the methods, while the various steps have been described in a particular order, it will be apparent for a person skilled in the art that the order of at least some of these steps may be altered. It will also be apparent for a person skilled in the art that some steps may be optional and other steps may be added. While various embodiments have been described above, it should be understood that they have been presented by way of example only, and not limitation. In particular, it is, of course, not possible to describe every conceivable combination of components or methodologies for purposes of describing the claimed subject matter, but one of ordinary skill in the art may recognize that many further combinations and permutations are possible. Thus, the breadth and scope of the teachings herein should not be limited by any of the above described exemplary embodiments but should be defined only in accordance with the following claims and their equivalents.

1. A method for transferring a set of data using a color image, the method comprising the steps of:
dividing the set of data into a group of two or more data chunks;
assembling a color barcode image encoded with the set of data, wherein the color barcode represents a superposition of black-and-white two dimensional (2D) -barcode images, one black-and-white 2D-barcode image for each of said data chunks;
displaying the color barcode image on a color display of a sending device;
capturing a color image of the displayed color barcode image with a camera of a receiving device;
filtering the captured color image to obtain a series of black-and-white images;
processing each of the obtained series of black-and-white images to extract corresponding black-and-white 2D-barcodes;
decoding each of the extracted black-and-white 2D-barcodes to obtain corresponding decoded data chunks; and
combining the obtained decoded data chunks into a received set of data.

2. The method of claim 1 further comprising:
encoding each data chunk into an encoded black-and-white 2D-barcode;
assembling the encoded black-and-white 2D-barcodes into the color barcode image
wherein for each pixel of the color barcode image a corresponding black-or-white element is determined in each of the encoded black-and-white 2D-barcodes, and the color of each pixel of the color barcode image is determined as a function of the values of said determined corresponding black-or-white elements.

3. The method of claim 1 further comprising:
encoding each data chunk into an encoded black-and-white 2D-barcode;
generating for each encoded black-and-white 2D-barcode an intermediate black-and-white image, wherein all intermediate black-and-white images have the same dimensions;
assembling the intermediate black-and-white images into the color barcode image having the same dimensions as the intermediate black-and-white images, wherein for each pixel of the color barcode image the color of that pixel is determined as a function of the values of corresponding black-or-white pixels in each of the encoded black-and-white 2D-barcodes.

4. The method of claim 1 wherein one or more of the encoded black-and-white 2D-barcodes are formatted according to a 2D-barcode standard.

5. The method of claim 4 wherein one or more of the encoded black-and-white 2D-barcodes comprise a QR code (Quick Response Code).

6. The method of claim 1 wherein all encoded black-and-white 2D-barcodes are formatted according to the same format.

7. The method of claim 1 wherein all encoded black-and-white 2D-barcodes have the same dimensions.

8. An apparatus for receiving data encoded in a color image, the apparatus comprising:
a digital camera for capturing a digital color image; and
a data processing component adapted to process the captured digital color image wherein said processing comprises
filtering the captured digital color image to obtain a series of black-and-white images,
processing each of the obtained series of black-and-white images to extract corresponding black-and-white 2D-barcodes,
decoding each of the extracted black-and-white 2D-barcodes to obtain corresponding decoded data chunks, and
combining the obtained decoded data chunks into a received set of data.

9. The apparatus of claim 8 wherein the data processing component is further adapted to generate an electronic signature over the received set of data.

10. The apparatus of claim 9 further comprising a user output interface for presenting to a user of the apparatus at least one of messages or data, and a user input interface to receive from the user inputs, whereby the apparatus may be further adapted to present using the user output interface the received set of data to the user for review, to receive from the user using the user input interface an indication of approval or rejection of the presented received set of data, and to generate or make available the electronic signature over the received set of data only on condition that the apparatus received from the user an indication of approval of the presented received set of data.

11. The apparatus of claim 8 wherein said processing each of the obtained series of black-and-white images to extract corresponding black-and-white 2D-barcodes comprises:
processing a first black-and-white image of the obtained series of black-and-white images, wherein said processing of said first black-and-white image comprises analysing said first black-and-white image to obtain a set of parameters; and
using said obtained set of parameters in processing at least one black-and-white image of the obtained series of black-and-white images that is different from the first black-and-white image.

12. The apparatus of claim 11 wherein said set of parameters comprises a scaling parameter.

13. The apparatus of claim 11 wherein said set of parameters comprises a rotation parameter.

14. The apparatus of claim 11 wherein said set of parameters comprises one or more distortion parameters.

15. A system for transferring a set of data to a receiving apparatus using a color image, the system comprising:
an encoding unit adapted to generate a color barcode image encoding the set of data by
dividing the set of data into a group of data chunks,
encoding each data chunk into an encoded black-and-white 2D-barcode, and
assembling the encoded black-and-white 2D-barcodes into the color barcode image; and
a sending device comprising a color display for displaying the generated color barcode image.
